(19) United States
(12) Patent Application Publication
(10) Pub. No.: US 2014/0306652 A1
(43) Pub. Date: Oct. 16, 2014

(54) WIRELESS RECHARGEABLE ELECTRONIC DEVICE

(71) Applicant: ASKEY COMPUTER CORP., New Taipei City (TW)

(72) Inventor: Jui-Chuan Huang, New Taipei City (TW)

(73) Assignee: ASKEY COMPUTER CORP., New Taipei City (TW)

(21) Appl. No.: 14/043,857

(22) Filed: Oct. 2, 2013

(30) Foreign Application Priority Data
Apr. 12, 2013 (TW) 102113072

(51) Int. Cl. H02J 7/02

(52) U.S. Cl. CPC H02J 7/025
USPC 320/108

(57) ABSTRACT

A wireless rechargeable electronic device includes a body and a replaceable battery pack. The body includes a wireless charging control circuit. The replaceable battery pack includes a battery cell and a wireless charging induced circuit. The wireless charging induced circuit is adapted for generating an induced current, and the induced current is transmitted to the battery cell after passing through the wireless charging control circuit.

### CROSS-REFERENCE TO RELATED APPLICATION

This application claims the priority benefit of Taiwan application serial no. 102113072, filed on Apr. 12, 2013. The entirety of the above-mentioned patent application is hereby incorporated by reference herein and made a part of this specification.

### TECHNICAL FIELD

The invention relates to an electronic device, and more particularly, to a wireless rechargeable electronic device.

### BACKGROUND

With the development of technology, the electronic device such as a mobile phone, a tablet computer and a laptop has been popularly applied in the daily life. Generally speaking, in most of the electronic devices, electric energy is transmitted from stationary power supply (for example, utility grid) to the battery cells through the electric wires. However, plugging the electric wire into the electronic device or pulling the electric wire out of the electronic device frequently might cause damage of the contacts between the electric wire and the electronic device, and further cause the electronic device can not be charged successfully. In addition, it is not convenient to store the electric wire, and the electric wire is covered with dust easily. Accordingly, the wireless charging technology is provided.

At the present stage of the wireless charging technology, a battery cell of a wireless charging electronic device is charged by a wireless power supply apparatus in electromagnetic transformation way. The wireless power supply apparatus has an induced circuit which generates an alternating current magnetic field pushed by alternating current. The wireless charging electronic device has another induced circuit for receiving the alternating current magnetic field and transforming into electric energy which is used for charging the battery cell of the electronic device.

The wireless receiving module of the wireless charging electronic device is often disposed in the battery pack. After using, the battery pack ages and needs to be replaced. However, replacing the battery pack causes wastage of the wireless receiving module. Especially, the wireless receiving module has a wireless charging control circuit which is expensive.

### SUMMARY

A wireless rechargeable electronic device is provided in the disclosure. The wireless rechargeable electronic device has a cheaper replaceable battery pack, so that the wastage of the wireless receiving module is reduced while being dumped with the replaceable battery pack.

One of exemplary embodiments provides a wireless rechargeable electronic device. The wireless rechargeable electronic device comprises a body and a replaceable battery pack. The body comprises a wireless charging control circuit. The replaceable battery pack comprises a battery cell and a wireless charging induced circuit. The wireless charging induced circuit is adapted for generating an induced current, and the induced current is transmitted to the battery cell after passing through the wireless charging control circuit.

In one embodiment, the wireless charging induced circuit is fixed to the battery cell.

In one embodiment, the replaceable battery pack further comprises a cover, and the wireless charging induced circuit is disposed in the cover.

In one embodiment, the cover and the battery cell are integrated.

In one embodiment, the replaceable battery pack further comprises a gas gauge coupled to the battery cell.

In one embodiment, the replaceable battery pack further comprises a protecting circuit coupled to the battery cell.

In one embodiment, the body further comprises a dynamic power path management (DPPM) element coupled to the wireless charging control circuit.

In one embodiment, the wireless rechargeable electronic device is a mobile phone, a tablet computer or a laptop.

In one embodiment, the wireless charging induced circuit comprises an induction coil.

In one embodiment, the induction coil receives a charging signal so as to generate the induced current.

In view of the forgoing, in the wireless rechargeable electronic device of the disclosure, the expensive wireless charging control circuit which is disposed in the body, and the cheap wireless charging induced circuit which is kept in the replaceable battery pack. Therefore, the cost of the replaceable battery pack can be reduced. In addition, because the expensive wireless charging control circuit is kept in the body, while the battery cell ages and the replaceable battery pack needs to be replaced, the wastage of the wireless charging elements which are dumped with the replaceable battery pack can be reduced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic illustration of a wireless rechargeable electronic device according to one embodiment of the invention.

FIG. 2 is a schematic illustration of a wireless rechargeable electronic device according to another embodiment of the invention.

FIG. 3 is a schematic illustration of a wireless rechargeable electronic device according to another embodiment of the invention.

### DETAILDD DESCRIPTION OF EMBODIMENTS

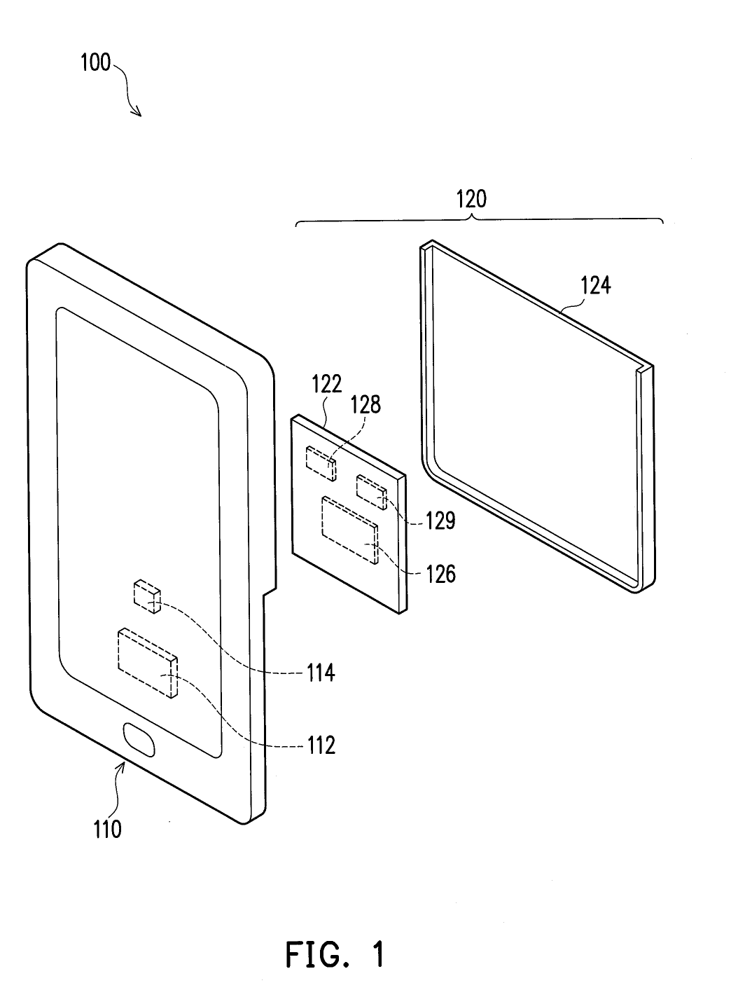

FIG. 1 is a schematic illustration of a wireless rechargeable electronic device according to one embodiment of the invention. In this embodiment, the wireless rechargeable electronic device 100 is a mobile phone, but the wireless rechargeable electronic device 100 also can be a tablet computer or a laptop in another embodiment. The type of the wireless rechargeable electronic device 100 is not limited thereto.

Referring FIG. 1, the wireless rechargeable electronic device 100 of this embodiment includes a body 110 and a replaceable battery pack 120. The body 110 includes a wireless charging control circuit 112. The replaceable battery pack 120 includes a battery cell 122, a cover 124 and a wireless charging induced circuit 126. While the replaceable battery pack 120 is assembled to the body 110, the battery cell 122 is located between the body 110 and the cover 124.

The wireless charging induced circuit 126, for example, is an induction coil. In the embodiment, the wireless charging method of the wireless charging induced circuit 126 is electromagnetic induction, but it is not limited thereto. In another embodiment, the wireless charging induced circuit 126 receives or sends a charging signal in another way, such as electric wave, electromagnetic field resonance, laser or electromagnetic wave transform, etc.

In the embodiment, the wireless charging induced circuit 126 is fixed to battery cell 122. The wireless charging induced circuit 126 is used for generating an induced current after receiving a wireless charging signal sent by a wireless power supply apparatus (not shown), and the induced current is transmitted to the battery cell 122 after passing through the wireless charging control circuit 112.

In detail, the wireless power supply apparatus can be coupled to a utility grid, and amplitude of alternating current provided by the utility grid can be reduced to the applicable value through a voltage step-down circuit (for example, a transformer) of the wireless power supply apparatus. Then, the alternating current can be transformed to magnetic field varied with time (i.e. the wireless charging signal) by an induction coil of the wireless power supply apparatus. After receiving the magnetic field varied with time, magnetic flux inside the wireless charging induced circuit 126 changes and generates the induced current. The induced current passes through the wireless charging control circuit 112 for being regulated, and then the induced current is transmitted to the battery cell 122 for charging.

In the embodiment, the replaceable battery pack 120 further includes a gas gauge 128 and a protecting circuit 129. The gas gauge 128 and the protecting circuit 129 are coupled to the battery cell 122, respectively. The gas gauge 128 is used for providing the information such as surplus power, surplus service time, voltage of the battery cell, temperature and average current measured value, etc. The protecting circuit 129 is used for protecting the battery cell 122 from charging excessively, discharging excessively or leaking current.

The body 110 further includes a dynamic power path management (DPPM) element 114 coupled to the wireless charging control circuit 112. The DPPM element 114 can separate the current into two ways. Some current is transmitted to the body 110 through one way, and some current charges the battery cell 122 through the other way.

In the wireless rechargeable electronic device 100 of this embodiment, the cheap wireless charging induced circuit 126 is disposed in the replaceable battery pack 120, and the expensive wireless charging control circuit 112 is disposed in the body 110. The cost of the replaceable battery pack 120 can be reduced effectively. In addition, while the battery cell 122 ages and the replaceable battery pack 120 needs to be replaced, the expensive wireless charging control circuit 112 is still kept in the body 110 so as to prevent wastage.

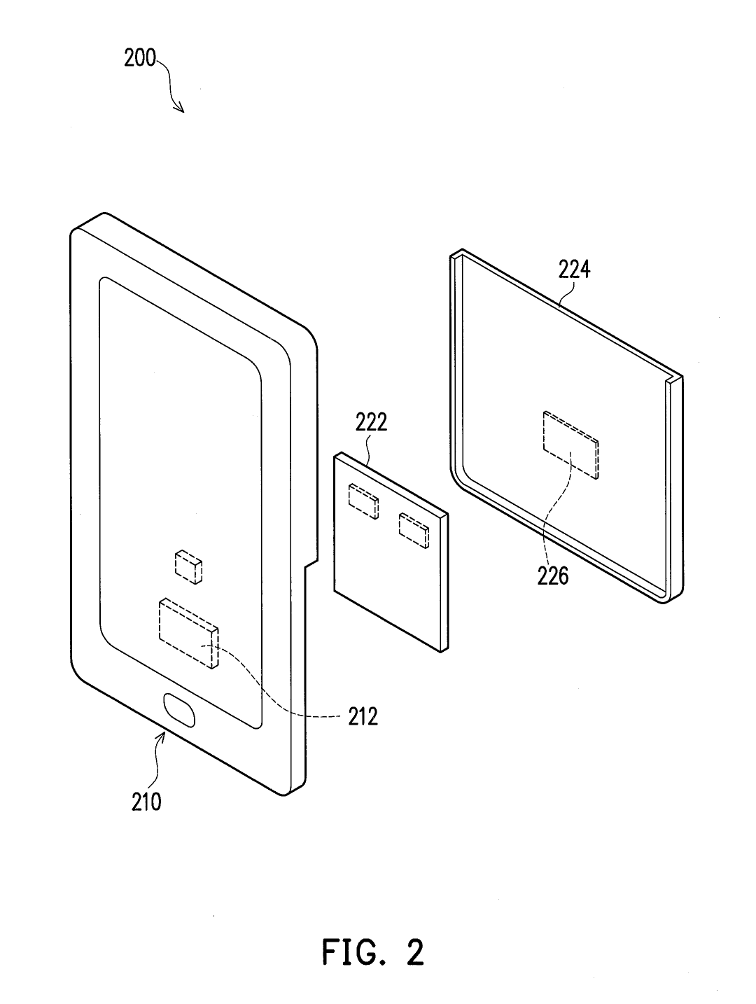

FIG. 2 is a schematic illustration of a wireless rechargeable electronic device according to another embodiment of the invention. Referring to FIG. 2, the main difference between the wireless rechargeable electronic device 200 of FIG. 2 and the wireless rechargeable electronic device 100 of FIG. 1 is that the wireless charging induced circuit 226 of the wireless rechargeable electronic device 200 in FIG. 2 is disposed in the cover 224. That is, while the battery cell 222 ages and needs to be replaced, the wireless charging control circuit 212 is still kept in the body 210 and the wireless charging induced circuit 226 is still kept in the cover 224. The wireless charging control circuit 212 and the wireless charging induced circuit 226 are not dumped with the battery cell 222 so that the wastage of resource can be prevented.

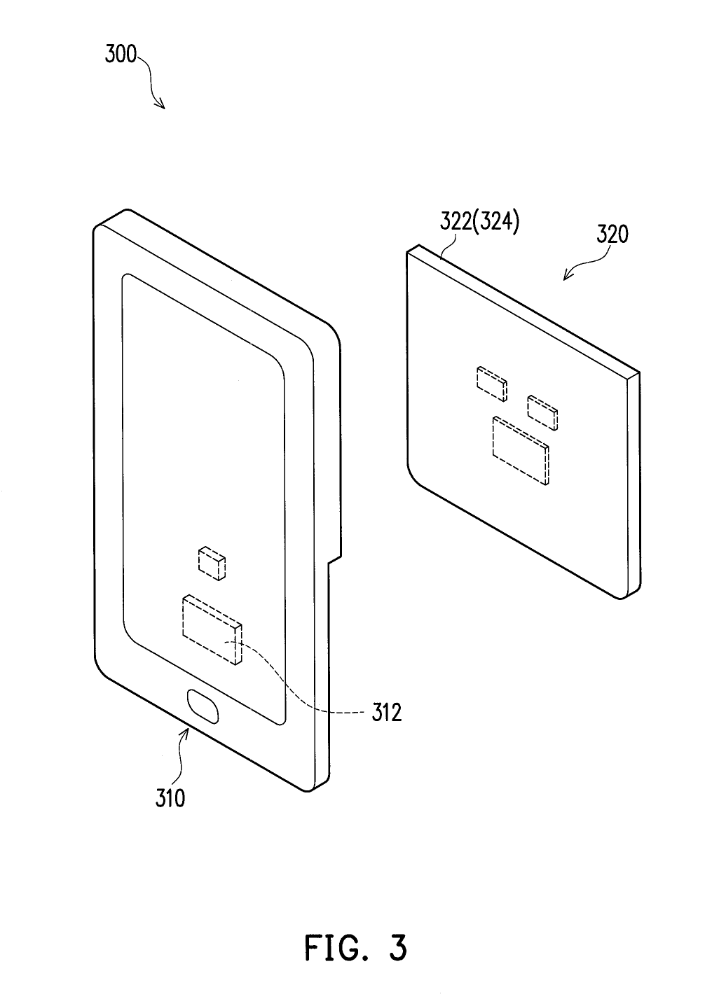

FIG. 3 is a schematic illustration of a wireless rechargeable electronic device according to another embodiment of the invention. Referring to FIG. 3, the main difference between the wireless rechargeable electronic device 300 of FIG. 3 and the wireless rechargeable electronic device 100 of FIG. 1 is that the cover 324 and the battery cell 322 are integrated in FIG. 3. In other words, at least one lateral of the battery cell 322 is exposed out of the wireless rechargeable electronic device 300. A part of shell of the battery cell 322 is used as the cover 324 of the body 310. User can configure the whole replaceable battery pack 320 to the body 310 in one step. Because the wireless charging control circuit 312 of the wireless rechargeable electronic device 300 in FIG. 3 is still disposed in the body 310, while replacing the replaceable battery pack 320, wastage of the wireless charging control circuit 312 can be prevented.

As the description above, in the wireless rechargeable electronic device of the disclosure, the expensive wireless charging control circuit is disposed in the body, and the cheap wireless charging induced circuit is kept in the replaceable battery pack. Therefore, the cost of the replaceable battery pack can be reduced. In addition, because the expensive wireless charging control circuit is kept in the body, while the battery cell ages and the replaceable battery pack needs to be replaced, the wastage of the wireless charging elements which are dumped with the replaceable battery pack can be reduced.

What is claimed is:

1. A wireless rechargeable electronic device, comprising:
a body, comprising a wireless charging control circuit; and
a replaceable battery pack, comprising a battery cell and a wireless charging induced circuit, wherein the wireless charging induced circuit is adapted for generating an induced current, and the induced current is transmitted to the battery cell after passing through the wireless charging control circuit.

2. The wireless rechargeable electronic device as claimed in claim 1, wherein the wireless charging induced circuit is fixed to the battery cell.

3. The wireless rechargeable electronic device as claimed in claim 1, wherein the replaceable battery pack further comprises a cover, and the wireless charging induced circuit is disposed in the cover.

4. The wireless rechargeable electronic device as claimed in claim 3, wherein the cover and the battery cell are integrated.

5. The wireless rechargeable electronic device as claimed in claim 1, wherein the replaceable battery pack further comprises a gas gauge coupled to the battery cell.

6. The wireless rechargeable electronic device as claimed in claim 1, wherein the replaceable battery pack further comprises a protecting circuit coupled to the battery cell.

7. The wireless rechargeable electronic device as claimed in claim 1, wherein the body further comprises a dynamic power path management element coupled to the wireless charging control circuit.

8. The wireless rechargeable electronic device as claimed in claim 1 is a mobile phone, a tablet computer or a laptop.

9. The wireless rechargeable electronic device as claimed in claim 1, wherein the wireless charging induced circuit comprises an induction coil.

10. The wireless rechargeable electronic device as claimed in claim 9, wherein the induction coil receives a charging signal so as to generate the induced current.
